(19) United States
(12) Patent Application Publication
(10) Pub. No.: US 2014/0186488 A1
(43) Pub. Date: Jul. 3, 2014

(54) DEVICE FOR SEPARATING BLOCK FROM MOLDING CORE

(71) Applicant: HON HAI PRECISION INDUSTRY CO., LTD., New Taipei (TW)

(72) Inventor: MIN-TSANG TSENG, New Taipei (TW)

(73) Assignee: HON HAI PRECISION INDUSTRY CO., LTD., New Taipei (TW)

(21) Appl. No.: 13/873,238

(22) Filed: Apr. 30, 2013

(30) Foreign Application Priority Data
Dec. 27, 2012 (TW) 101150696

(51) Int. Cl. B29C 33/44

(52) U.S. Cl. CPC B29C 33/442
USPC 425/577

(57) ABSTRACT

A device is used for separating a molding core and a block in a molding groove of the molding core. The device includes a substrate, an abutting element, and a pushing element. The substrate includes a first fixing plate and a second fixing plate opposite to the first fixing plate. The abutting element is fixed on the firs fixing plate, and extends towards the second fixing plate. The second fixing plate defines a threaded hole. The pushing element defines a screw thread coupled with the threaded hole. The pushing element has an end adjacent to the first fixing plate. The end of the pushing element defines a receiving groove. The pushing element can rotates in the threaded hole to push the molding core to move towards the first fixing plate, and thus the abutting element enters into the molding groove to push the block into the receiving groove.

### BACKGROUND

1. Technical Field

The present disclosure relates to a device for separating a molding core and a block received in the molding core.

2. Description of Related Art

In an injection molding process, a plastic block can block a cavity of a molding core. Currently, users fix the molding core using a clamping device, and knock the plastic block using hammers or other tools, which is time consuming and the molding core is easily damaged.

Therefore, it is desirable to provide a separating device that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a separating device, according to an exemplary embodiment.

FIG. 2 is a schematic, exploded view of the separating device of FIG. 1.

FIG. 3 is similar to FIG. 1, but showing the separating device in a working state.

### DETAILED DESCRIPTION

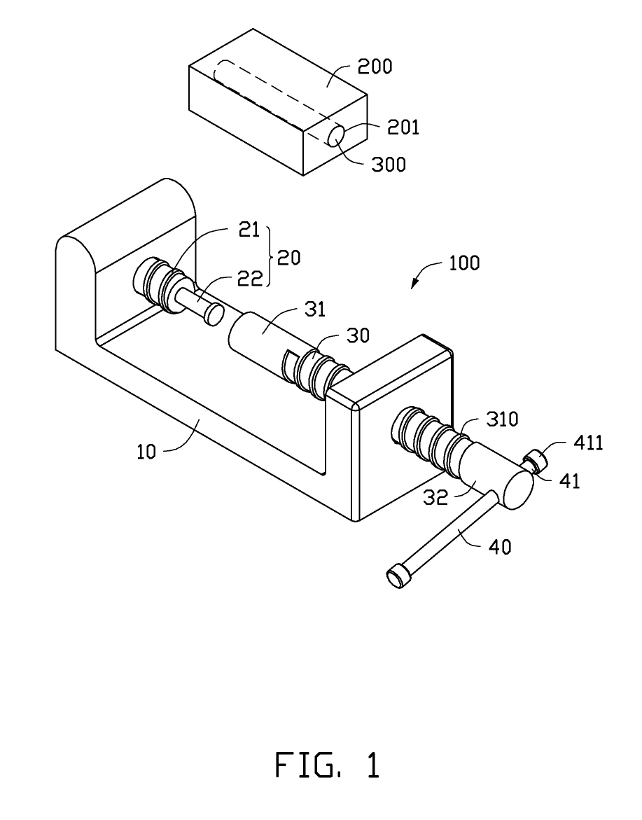

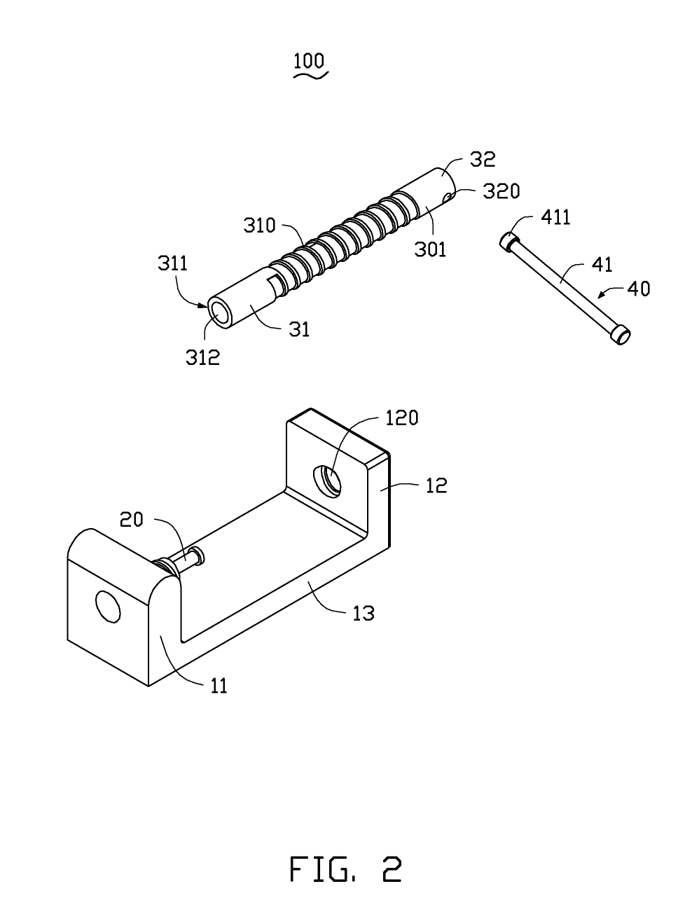

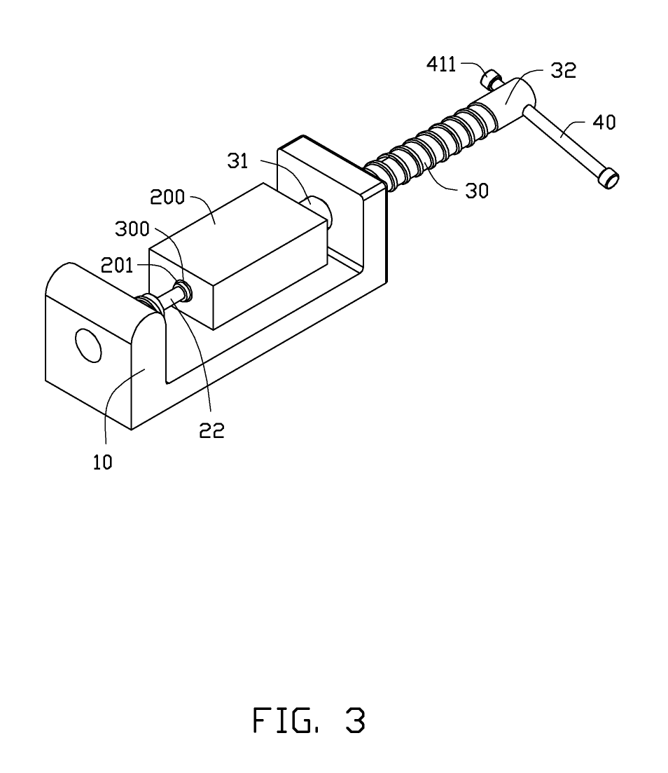

FIGS. 1-3 illustrate a separating device 100 in accordance with an embodiment. The separating device 100 is used for separating a molding core 200 and a block 300 plugged in a cavity 201 of the molding core 200. The separating device 100 includes a substrate 10, an abutting element 20, a pushing element 30, and a lever 40.

The substrate 10 is substantially U-shaped, and includes a first fixing plate 11, a second fixing plate 12, and a connecting plate 13. The second fixing plate 12 is opposite to the first fixing plate 11, and is parallel to the first fixing plate 11. The connecting plate 13 is perpendicularly connected to the first fixing plate 11 and the second fixing plate 12.

The abutting element 20 includes a fixing portion 21 and an abutting portion 22. The fixing portion 21 is fixed to the first fixing plate 11. The abutting portion 22 extends from the fixing portion 21 towards the second fixing plate 12. The abutting portion 22 can extend into the cavity 201 to push the block 300 to move in the cavity 201. In the embodiment, the fixing portion 21 is screwed to the first fixing plate 11.

The second fixing plate 12 defines a threaded hole 120 perpendicularly passing through two opposite surfaces of the second fixing plate 12.

The pushing element 30 is hollow pole-shaped, and inserts into the threaded hole 120. An outer sidewall 301 of the pushing element 30 defines a screw thread 310 engaged with the threaded hole 120, and thus the pushing element 30 can move towards or far away from the first fixing plate 11 when the pushing element 30 is rotated.

The pushing element 30 has a first end 31 adjacent to the abutting element 20, and a second end 32 opposite to the first end 31. The first end 31 has an end surface 311 facing the abutting element 20. The end surface 311 defines a receiving groove 312 for receiving the block 300. The size of the receiving groove 312 is greater than the size of the block 300, and thus the block 300 can be taken out from the receiving groove 312. The second end 32 has an outer sidewall 301 defining a fixing hole 320. The fixing hole 320 perpendicularly passes through the second end 32, that is, an extending direction of the fixing hole 320 is substantially perpendicular to a lengthwise direction of the pushing element 30.

The lever 40 has a fixing end 41 passing through the fixing hole 320, and thus the lever 40 can drive the pushing element 30 to rotate in the threaded hole 120 around the fixing end 41. In the embodiment, the fixing end 41 is sleeved a cap 411 at a terminal thereof to prevent the lever 40 from separating from the pushing element 30. In other embodiments, the lever 40 also can be omitted, and users can rotate the pushing element 30 using other tools.

In use, the molding core 200 is mounted between the abutting element 20 and the pushing element 30, thus the abutting element 20 abuts the block 300 and the pushing element 30 abuts the molding core 200. The lever 40 can be rotated around a fulcrum (such as the fixing end 41), and thus lever 40 drives the pushing element 30 to rotate in the threaded hole 120, and the abutting element 20 extends into the molding core 200 and pushes the block 300 to move towards the pushing element 30 until the block 300 enters the receiving groove 312, therefore the block 300 is removed from the molding core 200. The lever 40 can rotate backwards until the abutting element 22 is removed from the molding core 200. At last, the block 300 can be taken out from the receiving groove 312.

By employing the separating device 100, the pushing element 30 is rotated in the threaded hole 120 to separate the block 300 from the molding core 200, which is very convenient and safe, and the molding core 200 can be effectively protected.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A device for separating a molding core from a block in a molding groove of the molding core, the device comprising:
a substrate comprising a first fixing plate and a second fixing plate opposite to the first fixing plate, the second fixing plate defining a threaded hole;
an abutting element fixed to the first fixing plate, and extending towards the second fixing plate, and
a pushing element defining a screw thread engaged with the threaded hole, and having a first end adjacent to the first fixing plate, the first end defining a receiving groove, wherein when the pushing element rotates in the threaded hole to push the molding core to move towards the first fixing plate, and the abutting element enters into the molding groove to push the block into the receiving groove.

2. The device of claim 1, wherein the pushing element comprises a second end opposite to the first end, the second end has an outer sidewall defining a fixing hole, the device comprises a lever, and the lever has a fixing end received in the fixing hole, and thus the lever is capable of rotating the pushing element using the fixing end as a fulcrum.

3. The device of claim 2, wherein the fixing hole passes through the pushing element, an extending direction of the fixing hole is substantially perpendicular to a lengthwise direction of the pushing element, the lever comprises a cap at the fixing end to prevent the lever from separating from the pushing element.

4. The device of claim 1, wherein the abutting element has a fixing portion and an abutting portion extending from the fixing portion, the fixing portion is fixed to the first fixing plate, the abutting portion extends towards the second fixing plate, and the abutting portion extends into the molding core.

5. The device of claim 1, wherein the substrate comprises a connecting plate connecting the first fixing plate and the second fixing plate.

6. The device of claim 1, wherein the first fixing plate is substantially parallel to the second fixing plate.
